(19) United States
(12) Patent Application Publication
(10) Pub. No.: US 2008/0229341 A1
(43) Pub. Date: Sep. 18, 2008

(54) DISC TRANSPORT WITH AN IMPROVED DISC ENGAGEMENT MECHANISM

(76) Inventors: Dale K. Kubin, San Diego, CA (US); Nathan P. Scherdin, San Diego, CA (US)

Correspondence Address: DOBRUSIN & THENNISCH PC, 29 W LAWRENCE ST, SUITE 210, PONTIAC, MI, 48342, US

(21) Appl. No.: 11/844,593

(22) Filed: Aug. 24, 2007

Related U.S. Application Data
(60) Provisional application No. 60/895,167, filed on Mar. 16, 2007.
(60) Provisional application No. 60/945,202, filed on Jun. 20, 2007.

(51) Int. Cl. G11B 17/04

(52) U.S. Cl. 720/619

(57) ABSTRACT

The present invention provides an apparatus for supporting and transferring a storage disc comprising a disc engagement mechanism including at least one movable component, the at least one movable component including a first component having a first upper plate and an apex, a valley configured to support a first portion of the first disc, the first portion located beneath the first upper plate, and a second component having a second upper plate, a sidewall that is generally perpendicular to the second upper plate and a tapered lip.

### CLAIM OF PRIORITY

The present invention claims the benefit of the priority of the filing date of U.S. Provisional Application Ser. No. 60/895,167 filed Mar. 16, 2007 and U.S. Provisional Application Ser. No. 60/945,202 filed Jun. 20, 2007, which are herein incorporated by reference for all purposes.

### FIELD OF INVENTION

The present invention relates to disc transport devices and more specifically to disc engagement mechanisms adapted to selectively engage storage devices for transfer thereof.

### BACKGROUND OF THE INVENTION

Media device manufacturers currently provide consumers with disc publishing devices configured for processing media (such as storage discs, or otherwise). Such processing requires the use of a disc transport for engagement and movement of storage media to components of the publishing devices for processing therein. Recently, disc-publishing devices manufacturers have attempted to improve the features of disc engagement mechanisms for disc transport devices that can selectively engage a single disc consistently without engaging additional discs simultaneously.

However, the disc-publishing devices have failed to provide a disc transport device having an efficient disc engagement mechanism. As an example, in order for these disc-publishing devices to produce multiple processed discs with limited user interaction using typical disc engagement mechanisms, they require the use of a disc transport that can repeatedly engage storage discs using primarily radial forces. This use of radial force to engage storage disc can decrease the life expectancy of the engagement mechanism through excessive wear of its components, while also increasing the likelihood of an undesirable double disc pick, which slows down disc production. As such, once a double disk pick occurs and more than one disc is engaged, the user must stop the disc processing, remove the double picked discs, and restart the disc processing from the beginning by attempting to engage a first disc from the top of a disc stack.

Accordingly, at a minimum, there is a need for a more efficient disc engagement mechanism for disc transport devices that are capable of engaging and moving preferably one storage disc. In addition, there is a need for a disc transport device having an engagement mechanism that is capable of separating adjacent discs, so as to engage the top disc for movement thereof.

### SUMMARY OF THE INVENTION

The present invention overcomes the drawbacks of the prior art by providing a disc transport device having an improved disc engagement mechanism that is configured for more efficient operation and orientation of the disc engagement mechanism's features for the selectively engaging and handling storage media. Advantageously, this disc engagement mechanism further provides a double disc pick removal feature, which advantageously improves disc processing for an individual use, small business, or otherwise, and which is more user friendly than prior art disc transport devices.

In one aspect, the present invention meets the above needs by providing a disc transport having a disc engagement mechanism that minimizes the use of radial forces to engage a disc by incorporating improved features that selectively engage a disc by supporting it from beneath. This disc engagement mechanism comprises a first component having a first upper plate and a tapered flange having an apex, wherein the first upper plate and the tapered flange define a valley therebetween, the valley is configured to support a first portion of a first disc, a second component having a second upper plate, a tapered lip, and a sidewall that is generally perpendicular to the second upper plate.

In another aspect, the present invention provides for a disc separation feature for separating adjacent discs. As such, the present invention provides a method for separating adjacent discs by inserting at least one flanged feature of the disc engagement mechanism between at least a portion of the adjacent discs, thereby separating the adjacent discs during the process of engaging a top disc.

In yet another aspect, the present invention provides for a disc double pick feature that reduces or eliminates the disc engagement mechanism from engaging more than one disc during the process of engaging a top disc. Accordingly, the present invention provides a method for removing one or more underlying adjacent discs from a double disc pick by reducing the amount of outward force subjected on the adjacent discs so that any disc being held by purely annular force will slide off due to gravity while retaining a top disc that is additionally supported from beneath.

### BRIEF DESCRIPTION OF THE DRAWINGS

FIG. 1 is a perspective view of one embodiment of the present invention.

FIG. 2 is a side view of another embodiment of the present invention.

FIG. 3 is a perspective view of one aspect of the present invention.

FIG. 4 is a side view of another embodiment of the present invention.

FIG. 5 is a side view of another aspect of the present invention.

FIG. 6 is a perspective view of yet another aspect of the present invention.

### DETAILED DESCRIPTION OF THE INVENTION

The present invention provides a disc transport device for engaging and transferring storage media, including, but not limited to: compact discs, digital video discs, mini discs, the like, combinations thereof or otherwise. More specifically, the disc transport device is adapted to provide an improved disc engagement mechanism for engaging and/or separating discs, while optionally removing an adjacent double picked disc. Advantageously, the disc transport with the improved disc engagement mechanism, can be adapted for use in a disc-publishing device for engaging and transferring storage discs to one or more media components for processing by way of printing and/or recording to a disc as disclosed in U.S. application Ser. No. 11/335,381 entitled “Printer” and is herein incorporated by reference for all purposes.

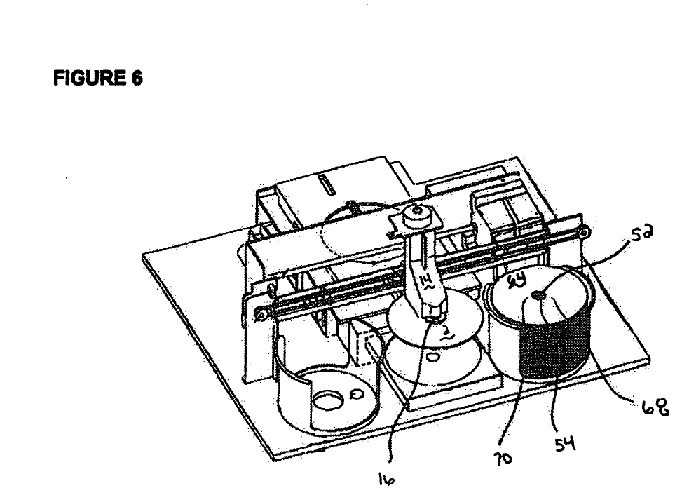

Referring to the drawings, exemplary embodiments and features of the present invention are shown. In one embodiment as shown in a disc-publishing device 10, (FIG. 6), the present invention provides a disc transport 14 adapted to engage and move one or more discs, preferably one at a time. The disc transport has independent movement capabilities and is controlled by a controller, which may be attached to the disc transport or may be part of another component of the disc-publishing device. Advantageously, the disc transport is configured with a disc engagement mechanism that is adapted to engage a disc, preferably by supporting portions of the disc, for subsequent movement thereof.

The disc transport is adapted to move along a substantial portion of a first slide member. Accordingly, the device further includes drive means linkably attached to the disc transport, via a linkage or otherwise, to provide a suitable force to move the disc transport to various points along the first slide members. Suitable drive member may include a stepper motor or other suitable drive members used for moving a printer component along a bearing surface or the like. Suitable linkages include belts, cables, chains, screws, the like or otherwise. In a preferred embodiment, the linking mechanism comprises a belt. However, it should be appreciated that numerous types of drive assemblies and linkages are available and may be used, as are commonly utilized in the design of inkjet printers.

The first slide member may comprise of any member adapted to guide an attached member along a portion of its length, width or otherwise. Suitable guiding feature include tracks, shafts, rails, grooves, the like or otherwise. Suitable elongated members include shafts, rods, beams, rails, the like or otherwise.

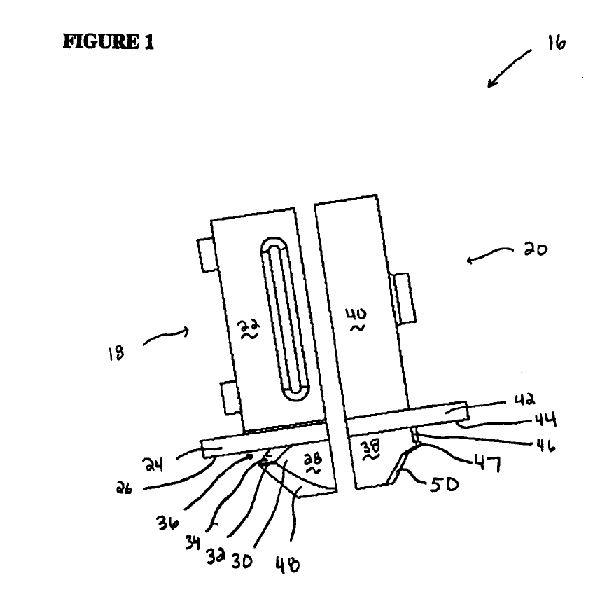

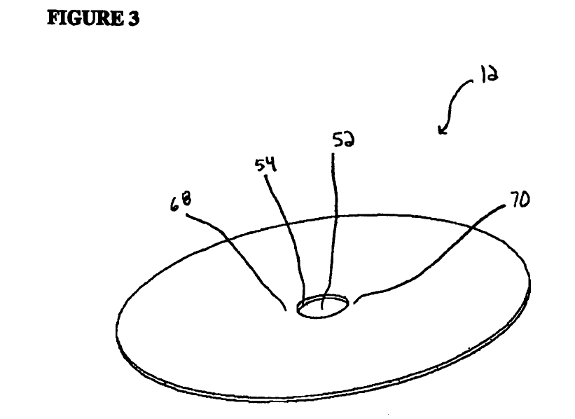

As previously mentioned, the disc transport includes a disc engagement mechanism adapted to selectively engage a disc portion. The engagement mechanism includes a first finger 18 and a second finger 20, (FIG. 1), which are movable, with respect to one another, along one or more axes. The first finger includes a base component 22, which extends downward from a bottom portion of the disc transport to a first upper plate 24. The first upper plate extends radially from the bottom section of the base in a generally parallel direction to that of the storage disc 12, (FIG. 3). Accordingly, the first upper plate has a generally flat bottom wall 26 that provides support for the disc portion located therebelow. Furthermore, the first upper plate provides a guide for the disc transport, wherein upon insertion of the disc engagement mechanism, the first finger is lowered until the first upper plate contacts the disc portion, therebelow. The position of the first upper plate ensures that the first finger is inserted into a disc hole at an optimum depth for engagement of the disc.

Extending beneath the first upper plate is the first head 28, which includes a tapered flange 30 having an apex 32. The apex is configured to separate adjacent discs during the engagement of the disc. The disc separation feature associated with the apex of the tapered flange minimizes double disc pick as discussed below. The tapered flange has an upper wall 34, which extends upward from the apex to an inner portion of the first upper plate bottom wall. The upper wall of the tapered flange and the bottom wall of the first upper plate define a generally V-shaped valley 36, therebetween. Advantageously, the valley includes an opening that has a height greater than the thickness of a disc, (and optionally less than two discs), as such, the valley is configured for supporting a portion of a disc located therein during the engagement process.

The second finger of the engagement mechanism also includes a base component 40, which extends downward from the bottom portion of the disc transport to a second upper plate 42. The second upper plate extends radially from the bottom section of the base in a generally parallel direction to that of the storage disc. Similar to the first upper plate, the second upper plate has a generally flat bottom wall 44 that provides support for a disc portion located therebelow. Furthermore, the second upper plate provides a guide for the disc transport, wherein upon insertion of the disc engagement mechanism, the second finger is lowered until the second upper plate contacts the disc portion, therebelow. The position of the second upper plate ensures that the second finger is inserted into a disc hole at an optimum depth for engagement of the disc.

Extending beneath the second upper plate is the second head 38 of the second finger, which includes a generally vertical inner sidewall 46. The sidewall extends downward and generally perpendicularly from an inner portion of second upper plate bottom wall and is configured for displacing a disc. Accordingly, the inner sidewall has a height generally approximate to the thickness of a horizontally placed storage disc therein, which advantageously helps displace the disc during the engagement process. The second head further includes a tapered lip 47 that protrudes outward at the bottom of the inner sidewall. The tapered lip provides additional support for an engaged disc and prevents the disc from being released from the engagement mechanism as discussed herein.

Optionally, the first and second fingers may further include angled down-standing walls 48 and 50, respectively. The angled walls are configured for guiding the first and second heads into the disc hole during the insertion of the engagement mechanism. Additionally, during the insertion of the engagement mechanism into a stack of discs, the angled walls may further be configured to align staggered discs therein.

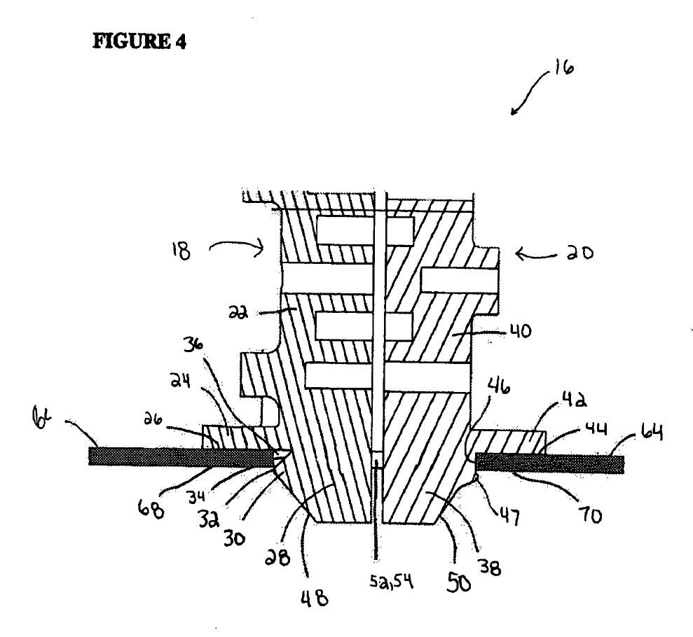

The first and second fingers, when combined, form a diameter that generally corresponds to the disc hole 52 formed in the disc and are adapted to move relative to each other. In a first position, the fingers are in a closed position wherein the resulting diameter of the fingers is less than the diameter of the disc hole. Accordingly, the fingers can move into the disc hole without substantial interference. In a second position, (FIG. 4), the fingers are in an open position, wherein the first and second fingers separate and form a diameter that is equal to or greater than the diameter of the disc hole such that the fingers engage the disc by supporting the inner walls 54 of the disc hole. As discussed above, it should be appreciated that the fingers engage the disc by supporting the interior walls 54 of the disc hole and optionally form a friction fit through an application of pressure by the fingers. The support of the disc from its underside is accomplished using flanges or lips on one or both fingers, or otherwise.

It is contemplated that the engagement mechanism is adapted to move one or both fingers for engagement and disengagement of a disc. Furthermore, it is contemplated that the first and second fingers are movable simultaneously or independently of each other. In a preferred embodiment, the first finger is stationary and the second finger is movable in at least one axis, which is generally parallel to the storage disc. Optionally, the engagement mechanism may be further configured to move the first finger and/or the second finger distances between the open and closed positions, greater than the open position, less than the closed position, or combinations thereof.

In view of the foregoing, it should be appreciated that upon engagement with a disc, e.g., movement of the fingers from a first position to a second position, the disc can be moved along the first slide member to different regions of the disc-publishing devices. Accordingly, when the disc transport reaches a desired location, the engagement fingers move back to the first position, thereby resulting in the disengagement of the disc with the engagement mechanism.

Advantageously, the engagement mechanism further comprises a disc-separating feature. Double disc picking is a symptom that occurs in typical disc transports for disc engagement. Because there is no known way to predict the exact space between a top disc and the underlying adjacent disc, storage discs are manufactured to have a stacking inner ring that typically has a smaller thickness than the outer surface of the disc. This smaller thickness of the inner ring provides for some space between the inner rings of adjacent discs for further separation thereof. To overcome a double disc pick, the disc transport utilizes a reduction in the amount of outward force applied to the inner ring of the disc, so that any disc being held by purely annular force will be disengaged. Optionally, or as an alternative, the disc transport may utilize at least one of the tapered flange and the tapered lip, which after separation of the adjacent discs, additionally provide support to the top disc from underneath. These methods of disc separation and engagement eliminates the reliance on the inner ring wall of the top disc being flat or the there being a known depth between the adjacent discs. Additionally, by using a supporting method for disc engagement, there is a reduced reliance on the need for radial forces to engage a disc. Advantageously, the mechanical force required to pick and engage a disc is greatly reduced, therefore, extending the service life of the engagement mechanism. The preferred method to handle a double disc picking is discussed below.

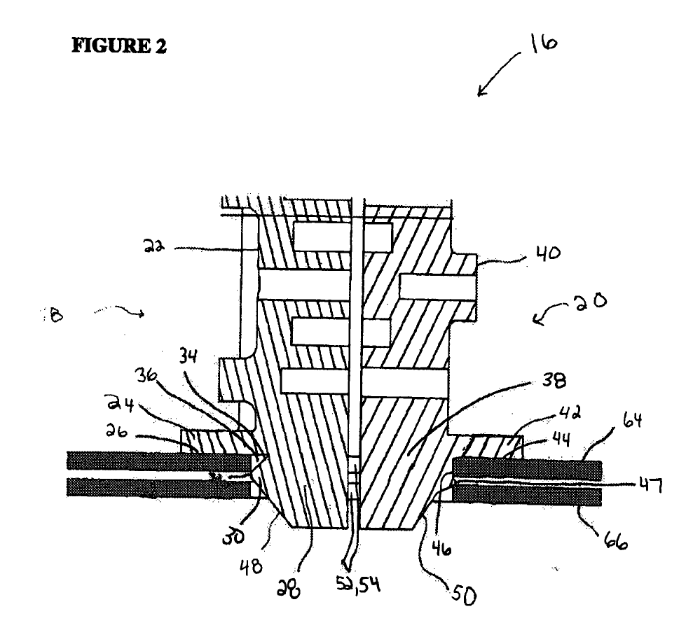

For example, FIG. 2 illustrates a proper disc pick by the present invention from a generally vertical stack of discs. The stack of discs includes a top disc 64 and a bottom disc 66, the top disc having a first inner ring portion 68 and a second inner ring portion 70 (FIG. 3). Upon movement from the closed position to the open position of the first and second fingers, the top and bottom discs are separated through force of the second finger propelling outward of the first finger. As such, the tapered flange and the tapered lip are propelled between the top and bottom discs, thereby separating the discs. In the open position and after separation of the top and bottom discs, the first and second inner ring portions of the top disc are supported between the tapered flange and the first upper plate of the first finger and the tapered lip and the second upper plate of the second finger for engagement thereof.

More specifically, there is typically a gap between the center stacking rings surrounding the holes of two adjacent discs. As the two adjacent discs are engaged using some outward force by the first and second fingers, at least one of the tapered flange or the tapered lip will slip into the gap between the two adjacent discs thereby supporting at least a portion of the top disc. By reducing the amount of outward force on the two adjacent discs, any disc being held by purely annular force will slide off due to gravity. Accordingly, once the double picked disc is disengaged and the bottom disc slides off the disc engagement mechanism, the unsupported portion of the top disc will thereafter become supported by the remaining tapered flange or tapered lip before the top disc can slip off the engagement mechanism as well.

Simple physical, outward force can be reduced without moving the first and second fingers inward. At least one of the first and second fingers are still pushing outward just at a reduced force. The force is reduced enough so that gravity becomes the major force for disengaging double picked discs. As both adjacent discs begin to fall because of gravity, at least one of the first and second fingers still pushing outward. This dynamic method of reducing and/or eliminating a double disc pick causes at least one of the tapered flange and the tapered lip to slip into the gap between the two adjacent discs as they begin to fall, thereby catching the top disc.

Advantageously, the same mechanics apply in the case were the disc engagement mechanism does not double pick adjacent discs. The disc engagement mechanism is inserted into a stack of discs, wherein the first and second head are generally past the first disc and actually begin to press outward onto the inner ring of the second disc. If gravity is strong enough so that the disc engagement mechanism cannot lift the second disc due to insufficient annular force, at least one of the tapered flange and the tapered lip of the disc engagement mechanism will slip into the gap between the adjacent disc as the first and second heads are lifted.

In another embodiment, the bottom disc can be disengaged from a double disc pick using a partial retracting motion, which would require the retraction of at least one of the first and second fingers to be short enough so that the bottom disc begins to fall. Once the bottom disc begins to fall, the engagement mechanism would be released, (to the opened position) again prior to the bottom disc falling all the way past the engagement mechanism. Since both discs are in motion, the bottom disc will continue falling because there is not enough annular force to stop/hold the bottom falling disc. The disc engagement mechanism will instead slip between the two adjacent discs, (because of the gap between the two adjacent discs), as discussed herein.

The disc transport may further comprise one or more sensors, such as, in determining the position of the disc transport, weather the engagement mechanism is in alignment for engaging or disengaging a disc, or otherwise. Suitable sensors include pressure sensor, optical sensors, electro mechanical sensors, Hall Effect sensors or otherwise. By example, in one exemplary embodiment, the sensor is located on or associated with at least one of the tapered flange or tapered lip extending from the fingers of the engagement mechanism. The sensors determine when the engagement mechanism is flush with the disc so that upon separation of the first and second fingers, and hence between an upper and lower disc, the engagement mechanism will engage the upper disc.

In view of the forgoing, the present invention is adapted to work with one or more media components of a disc-publishing device for performing multiple tasks to create a final disc product. Of these tasks, one particularly useful task includes recording information to the disc for subsequent retrieval. Such information may include music, videos, files, or other types commonly recorded through optical means. Accordingly, the disc-publishing device further includes a digital recording device adapted to record information to a disc. The recording device is configured to receive a disc from the disc transport, subsequently record information to the disc and make the disc available to the disc transport for subsequent tasks or otherwise. It should be appreciated that the information to be recorded to the disc may originated from another component, input port, as described herein, or otherwise.

The recording device further includes a recording tray that extends perpendicularly the first slide member. In this exemplary embodiment, the tray is adapted to reside in a first retracted position, wherein information may be recorded, and extend to a second position for receiving and/or providing a disc to the engagement mechanism. It should be appreciated that movement of the tray may be achieved using common techniques used in compact disc and digital video disc players and recording devices, or otherwise.

In operation, the recording device extends the tray to an extended position for receiving a disc from the disc transport. Similar to the movement of the print tray, if not already located there, the recording tray moves to a position substantially in alignment with the engaged disc overhead. The disc transport lowers the disc into the recording tray and releases the disc. The disc transport then moves away from the recording tray and the recording tray is retracted to the first position for recording. Upon completion of recording to the disc, the recording tray extends to an extended position so that the center portion of the recording tray, more specifically, the disc hole within, is in alignment with the engagement mechanism of the disc transport, thereabove. The disc transport can retrieve the disc for further processing or otherwise. Advantageously, the recording device, more specifically, the recording tray may include calibration means to align the same with the engagement mechanism, thereabove.

Another useful task that may be performed with the present invention includes printing a design, text or otherwise to a disc for identification purposes, or otherwise. Accordingly, the disc-publishing device may further include a print assembly adapted to print to a disc using common printing techniques (e.g., inkjet laser or otherwise). In a preferred embodiment, the print assembly includes one or more print head and ink cartridges having colors commonly associated with inkjet printing (e.g., black, white, reds, blues, greens, combinations there of as otherwise). The print heads are mounted to a second slide member, which preferably extends along at least a portion of the housing and is mounted or otherwise secured thereto. It should be appreciated that the second slide member may include any of the features of the first slide member. The mounting of the print assembly to the second slide member provides movement along a second axis, which preferably is substantially perpendicular with the first axis but does not interfere with the movement of the disc transport located on the first slide member. It should be appreciated that the print head further includes a suitable drive means and linkages for movement of the print head along the second slide member. Suitable drive means and linkages may include any of the devices used for movement of the disc transport or any other suitable drive and/or linkage found in the art of disc-publishing devices and more particularly the drive configuration of print heads.

Advantageously, the print heads are adapted to print to a disc portion located within the print tray. Suitable print heads that can be used with the present invention can be found in the field of inkjet printing. However, printing to a disc using laser or thermal print technology is also within the present invention. In fact, it is contemplated that laser-printing technology may be used to print to a disc, which may include color. Regardless to the print means used, it should be appreciated that the disc-publishing device may print using any of the colors or color combinations found in the print industry.

The print assembly further includes a print tray adapted to receive a disc and provide movement thereabout, which preferably is substantially perpendicular to the movement of the printer heads. Advantageously, the print tray is adapted for movement along an axis to effectuate printing. For example, the print tray is moveable to a first position, which is fully extended and a second position, which is fully retracted. It should be appreciate that during printing, the print tray will move between the first and second position to provide print capability throughout the entire disc located within the print tray. However, upon the step of removing a processed disc from the disc-publishing devices, the print tray is configured for incremental movement, which allows for a plurality of intermediate positions for the print tray that are between a “fully extended” position and a “fully retracted” position. It is further appreciated, that the print tray may extend to positions beyond the “fully extended” and “fully retracted” positions, or otherwise.

The print tray is configured with a recess having a center adapted to be substantially concentrically aligned with a disc placed therein. Accordingly, in the extended position, the tray is adapted to receive a disc from the disc transport. For example, it is contemplated that when the disc tray is in a “fully extended” position, the recess portion is concentrically aligned with the center of the disc portion attached to the disc transport located thereabove. In this respect, the print tray is positioned so that the center portion of the print tray is in alignment with the engagement mechanism, wherein the disc transport proceeds to place the engaged disc into the print tray. In one configuration, placement of the disc into the print tray comprises lowering the engagement mechanism to the position just above the print tray, releasing the disc into the tray, and raising the engagement mechanism to a first (e.g., original) position. Advantageously, the printer assembly, more specifically, the print tray may include calibration means to align the same with the engagement mechanism, thereabove.

Movement of the print tray can be effectuated using any suitable drive mechanism, and any linkage thereto, adapted for specific positioning of the print tray, which may include reciprocal movement. Suitable drive mechanisms are known in the art of printing and may include stepper motors or otherwise. In a preferred embodiment, to effectuate specific positioning of the print tray, movement of the print tray is sequenced with the movement and printing of the print head. Preferably, the movement of the print tray and the print head are effectuated through a controller adapted to cause the print tray to move to one or more positions, as discussed herein, so that the one or more print heads can print to a specified region of the disc.

In a preferred embodiment, one or more of the components of the disc-publishing device are controllable through a controller. The controller of the disc transport may be included as a component of the disc transport or alternatively, the controller may be included with a separate component, e.g. not incorporated within the disc transport device. However, in a preferred embodiment, the controller is adapted to receive a signal from a source, such as a computer or otherwise, such that function of the disc-publishing device is based upon the received signal. Furthermore, preferably the controller causes synchronized operation of the components of the disc-publishing device (e.g., printing, recording, movement of the first and second fingers of the engagement mechanism, or otherwise) to maximize print efficiency by minimizing cycle time of any task to be performed.

For example, in one embodiment, it should be appreciated that the disc-publishing device may be communicatively connected to a device adapted to provide information pertaining to desired functions of the disc-publishing device. Suitable devices include processing unit (computers or otherwise) or the like, which preferably provides a user interface for allowing a user to selectively control the functions of the disc-publishing device. Accordingly, the disc-publishing device further includes one or more ports for providing communication between the controller of the disc-publishing device and the user interface, when the controller is an integral part of the disc-publishing device. Suitable communication devices include Universal Serial Bus (USB), parallel port, serial port, the like or otherwise.

In one exemplary method, the operation of the disc-publishing device is demonstrated as follows. A user selects one or more tasks to be performed by the disc-publishing device, via a user interface. As previously mentioned, such tasks may include recording to a disc, printing to a disc, or both. The user interface may be located proximate to the disc-publishing device or remote to the disc-publishing device (e.g., via a network connection, Internet or otherwise). It should also be appreciated that the user interface may comprise an integral component of the disc-publishing device (e.g., located externally or otherwise). Prior to assignment of a task to be performed by the disc-publishing device, the user places one or more discs at the disc supply receptacle.

Through the user Interface, the user selects one or more tasks to be performed to one or more discs. Often, as discussed below, the task includes both the recording and printing of information. For example, the tasks may include transferring data from a source to one or more discs, in a digital format. In addition, the tasks may also include printing to the recorded discs, which advantageously corresponds to the information transferred to the disc. Once the tasks have been selected, one or more signals are transferred to the controller of the disc-publishing device to effectuate synchronized operation of the disc-publishing device corresponding to the tasks requested.

For example, in one method of operation, upon transmission of the task signal to the disc-publishing device, the disc transport moves to the disc supply receptacle, wherein the engagement mechanism is aligned over the holes of the one or more discs located below, in the disc supply receptacle. Prior to engagement of a disc, the engagement mechanism is orientated in the closed position, wherein the second finger is compressed by mechanical means and is approximate to the stationary first finger. In the closed position, the combined first and second heads define a maximum lateral distance from the outer most edges of the tapered flange to the tapered lip, which is less than the diameter of the disc hole. Upon lowering the first and second fingers, the angled walls of the first and second heads provide guides for the engagement mechanism during insertion into the hole of a stack of discs. The angled walls may further provide alignment for a staggered stack of discs upon insertion therein.

The heads of the first and second fingers are lowered until the first and second upper plates are approximate to or are in contact with a top disc, located therebelow. Once the upper plates are approximate to the top disc, the tapered flange and the taper lip are generally flush with the inner ring of the disc. Accordingly, the tapered flange of the first head is generally flush with a first inner ring portion of the top disc and the tapered lip of the second head is generally flush with a second inner ring portion of the top disc. Thereafter, the second finger is propelled outward and away from the stationary first finger, to the open position.

As the second finger begins to propel outward, the tapered lip of the second head lifts the second inner ring portion of the top disc from the underlying adjacent disc towards the bottom wall of the second upper plate. Additionally, the movement of the second finger positions the second inner ring portion of the top disc against the inner wall of the second head, which further displaces the top disc outward relative to the movement of the second finger. The second inner ring portion of the top disc is thereafter supported between the second upper plate and the tapered lip for engagement thereof.

As the second finger shifts the second inner ring portion away from the first finger, the second inner ring portion is shifted towards the second finger, more specifically towards the apex of the tapered flange. The tapered flange of the second head then lifts and separates the first portion of the top disc from the underlying adjacent disc. As the first inner ring portion is propelled towards the first head, the first upper plate guides the first inner ring portion of the top disc to the tapered flange where the apex lifts the first inner ring portion into the V-shaped valley. The first inner ring portion of the top disc is secured into the V-shaped valley and supported between the first upper plate and the upper wall of the tapered flange for engagement thereof.

The tapered flange and the tapered lip support the top disc, which prevent the disengagement of the disc from the first and second fingers. As a result, the reliance on radial forces for disc engagement is minimized.

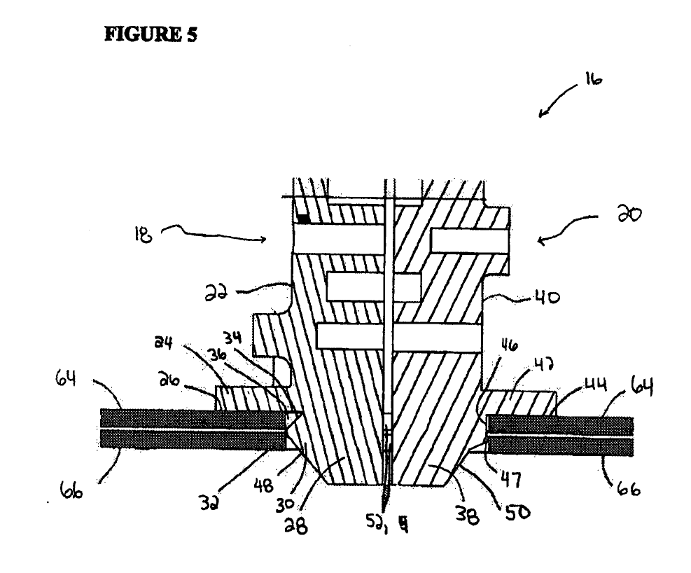

Situations occur wherein the outward movement of the second finger engages both adjacent discs that are stacked together, which is known as a double disc pick. As shown in FIG. 5, the engagement mechanism has engaged two discs using radial forces. More specifically, the outward force of the second finger has positioned the tapered flange between a top disc and a bottom disc, while the tapered lip is propelled against the inner ring portion of the bottom disc thereby engaging both the top and bottom discs. Accordingly, the engagement mechanism initiates a double pick feature, which reduces the outward force of the second finger on the second inner ring portion of the double picked bottom disc. The reduced outward force of the second finger in addition to gravity will cause both discs to begin to drop from the double disc pick of the second finger, while the first inner ring portion of the top disc remains supported by the valley of the first head. As both adjacent discs begin to drop, the reduced outward force allows the bottom disc to become disengaged while the tapered lip of the second finger slips between the adjacent discs thereby supporting the remaining second inner ring portion of the top disc.

Accordingly, the top disc is engaged and ready to be transported via the disc transport. The disc transport then raises with the engaged disc to its original position, e.g., above the disc supply receptacle, so as to prevent interference with the receptacle and an extended media tray during transferring of the engaged disc. Upon engagement, the disc is transported to one or more media components, preferably to both the recording device and the printer assembly.

The disc is moved to the recording device. Preferably, the tray of the recording device is extended so that the center portion of the disc attached to the engagement mechanism is substantially aligned with the center of the recording tray of the recording device. The engagement mechanism is then lowered proximate to the recording tray and releases the disc by compressing the first and second fingers together to the closed position. Upon placement of the disc into the recess formed on the recording tray, the engagement mechanism returns to an original position and the recording tray retracts into the recording device, wherein information is then recorded onto the disc.

Upon completion of recordation of data to the disc, the recording tray extends and the disc engagement mechanism lowers and once again inserts the first and second fingers in the disc hole, wherein the second finger is propelled outward, away from the first finger, thereby engaging the disc. The disc transport then moves the disc to the printer assembly. The disc printing tray then moves into an extending position and the disc transport, if necessary, aligns the center of the disc with the center recess form in the printing tray. The disc transport then lowers the disc onto the print tray in a similar fashion that was performed with the recording device. The engagement mechanism compresses the first and second fingers to the closed position, thereby releasing the disc. The disc transport then returns to an upward portion to clear the print tray so that is can retract to its retracted position and begin the printing task.

The printing tray then moves in synchronization with the print heads of the print assembly to effectuate printing to the surface of the disc. During this process, because of the decoupling of the disc transport and the print assembly, the disc transport moves back to the disc supply receptacle to retrieve another disc and place the disc into the recording device. It should be appreciated that this may be performed during printing to the disc.

Upon completion of the printing to the disc, and advantageously during recordation of data to the disc located in the recording device, the print assembly tray extends to its extended position. The disc transport then aligns itself with the disc located in the print tray, if necessary, and inserts into the disc hole the first and second fingers. Once inserted, the second finger is propelled outward away from the first finger, thereby positioning the tapered flange and the tapered lip beneath the disc for support and engagement thereof. The disc transport then transports the disc to one or more storage receptacles. The disc is then lowered proximate to the disc storage receptacle, wherein the second finger is compressed to the first finger thereby releasing the disc into the storage receptacle.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only three of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. An apparatus for supporting and transferring a storage disc comprising:
a disc engagement mechanism including at least one movable component, the at least one movable component including:
a first component having:
a first upper plate; and
an apex;
a valley configured to support a first portion of the first disc, the first portion located beneath the first upper plate; and
a second component having:
a second upper plate;
a sidewall that is generally perpendicular to the second upper plate; and
a tapered lip;
wherein the first and second components have a first position to define a first diameter that is generally smaller than the diameter of a hole of one or more discs, the first position configured for insertion thereof into the hole of the one or more discs; and
wherein the first and second components have a second position to define a second diameter that is generally larger than the diameter of the hole of the one or more discs, the second position configured to support the one or more discs for transfer to a target location.

2. The apparatus of claim 1, wherein at least one of the apex and the tapered lip is configured to separate a first disc from a second disc, the second disc being adjacent to and below the first disc.

3. The apparatus of claim 2, wherein the valley has a height between the apex of the tapered flange and the first upper plate that is generally greater than about the thickness of the first disc for supporting the first disc therein.

4. The apparatus of claim 3, wherein the height between the apex of the tapered flange and the first upper plate that is generally less than about the thickness of two discs.

5. The apparatus of claim 2, wherein the tapered lip is configured to support a second portion of the first disc.

6. The apparatus of claim 1, further comprising at least one down-standing angled wall for guiding at least one of the first and second components into the hole of the one or more discs.

7. The apparatus of claim 1, wherein the first component is stationary.

8. An apparatus for supporting and transferring a storage disc comprising:
a first component having:
a first upper plate; and
a tapered flange having an apex;
wherein the first upper plate and the tapered flange define a valley therebetween, the valley configured to support a first portion of a first disc; and
a second component having:
a second upper plate;
a tapered lip; and
a sidewall that is generally perpendicular to the second upper plate;
wherein the first component is stationary and the second component is movable along a first axis such that upon movement of the second component, at least one of the apex and the tapered lip is configured to separate a first disc from a second disc, the second disc being adjacent to and below the first disc.

9. The apparatus of claim 8, wherein the first and second components have a first position to define a first diameter that is generally smaller than the diameter of the hole of one or more discs, the first position configured for insertion thereof into the hole of the one or more discs.

10. The apparatus of claim 9, wherein the first and second components have a second position to define a second diameter that is generally larger than the diameter of the hole of the one or more discs, the second position configured to support the one or more discs for transfer to a target location.

11. The apparatus of claim 10, further comprising at least one down-standing angled wall for guiding at least one of the first and second fingers into the hole of the one or more discs.

12. The apparatus of claim 8, wherein the tapered lip is configured to support a second portion of the first disc.

13. The apparatus of claim 8, wherein the height of the valley between the apex of the tapered flange and the first upper plate is greater than the thickness of the first disc for supporting the first disc therein.

14. A method for supporting and transferring a storage disc comprising the steps of:
providing a disc engagement mechanism including:
a first component having:
a first upper plate; and
a tapered flange having an apex;
wherein the first upper plate and the tapered flange define a valley therebetween; and
a second component having:
a second upper plate;
a tapered lip; and
a sidewall that is generally perpendicular to the second upper plate;
inserting the disc engagement mechanism into a hole of one or more discs, thereby partially disposing the first and second components therein;
moving the second component generally along a first axis outward of the first component so as to contact the sidewall of the second component with a portion of an outer edge of a first disc;
displacing the first disc generally along the first axis through contact by the sidewall of the second component;
inserting at least one of the apex and the tapered lip between the first disc and a second disc, wherein the second disc is located adjacent to and beneath the first disc; and
engaging a first portion of the first disc, wherein the first portion is being supported within the valley.

15. The method of claim 14, wherein the step of inserting the disc engagement mechanism, the first and second components are in an insertion position, the insertion position defines a first diameter that is generally smaller than the diameter of the hole of one or more discs.

16. The method of claim 15, wherein the step of moving the second component generally along a first axis, the first and second components are in an engagement position, which defines a second diameter that is generally larger than the diameter of the hole of the one or more discs, the engagement position configured to support the one or more discs for transfer to a target location.

17. The method of claim 14, wherein the engaging step further includes a second portion of the first disc, the second portion being supported by the tapered lip.

18. The method of claim 14, wherein the engaging step, the valley is configured with a height between the apex of the tapered flange and the first upper plate that is greater than the thickness of the first disc for supporting the first disc therein.

19. The method of claim 14, wherein the step of moving the second component generally along a first axis, a reduced outward force is applied to at least one portion of the outer edge of the first disc, an outer edge of a second disc, or both, thereby enabling the first disc, the second disc, or both to begin to disengage from the disc engagement mechanism.

20. The method of claim 19, further comprising the step of moving the tapered lip into a gap between the first and second discs, thereby supporting a second portion of the top disc from therebeneath, while the second disc disengages from the disc engagement mechanism.
